(19) United States
(12) Patent Application Publication
(10) Pub. No.: US 2019/0106055 A1
(43) Pub. Date: Apr. 11, 2019

(54) Advanced Sunroof Lighting System

(71) Applicant: Tesla, Inc., Palo Alto, CA (US)

(72) Inventor: Joongmin Yoon, Mountain View, CA (US)

(73) Assignee: Tesla, Inc., Palo Alto, CA (US)

(21) Appl. No.: 15/726,647

(22) Filed: Oct. 6, 2017

(51) Int. Cl. B60Q 3/85; H05B 33/08; B60Q 3/74; B60Q 3/208; F21V 14/00

(52) U.S. Cl. CPC B60Q 3/85; H05B 33/0845; H05B 33/0863; F21Y 2115/10; B60Q 3/208; F21V 14/003; B60Q 3/74

(57) ABSTRACT

An advanced sunroof lighting system includes a sunroof having a first transparent layer and a second transparent layer substantially parallel to the first transparent layer. The sunroof also comprises a tint layer disposed between the first transparent layer and the second transparent layer. The tint layer is electrically controllable to allow a portion of light incident on the tint layer to pass through the tint layer. The sunroof further comprises a transparent lighting layer disposed between the tint layer and the second transparent layer. The transparent lighting layer comprises a plurality of light sources that are electrically controllable to emit light. The transparent lighting layer further comprises a plurality of scattering centers configured to redirect light received from the plurality of light sources towards the vehicle's cabin.

### TECHNICAL FIELD

The present disclosure relates to windows of a vehicle. More particularly, the present disclosure relates to a window system that allows for different performance under different operating conditions by providing lighting and varying the opaqueness of the window between clear and fully opaque.

### BACKGROUND

Windows within the roof of an automobile include different types and names, including sunroofs, moonroofs, panorama roofs, panoramic roofs, etc. (herein all referred to as a “sunroof”). A typical sunroof has a transparent glass layer. More advanced sunroofs have a screen or movable access door to block light when desired. The ability to control light is important. The driver and other vehicle occupants may want light in certain situations. In other situations, direct sunlight may be undesirable. For example, when it is hot outside, a driver and other vehicle occupants may not want direct light on them. Access doors can block sufficient light but are thick and often unsightly. Screens may impinge some, but not all light. Further, screen deployment require mechanical components, adding cost and potential failure points. Other sunroofs may be heavily tinted to impinge incoming light. However, these do not allow for sunlight to freely pass through when desired by the driver and other occupants. Also, the level of tinting may be insufficient certain conditions. For example, a lightly-tinted sunroof may not block enough sunlight in hot and bright conditions. Conversely, a heavily-tinted sunroof may block too much sunlight in overcast days.

Additional challenges of providing sufficient interior cabin lighting exist when sunroofs occupy most of the vehicle roof since lights are often overhead, mounted on the vehicle ceiling (underside of the roof). In addition, traditional lights are not uniform and provide non-uniform light and do not provide enough light in all areas of the vehicle. The brightness of the light is also not tunable to provide a range of lighting options from dim to bright.

Hence, there is a need for a sunroof lighting system that overcomes the aforementioned drawbacks.

### SUMMARY

The window according to the present disclosure introduces an advanced sunroof lighting system to allow a desirable amount of ambient light during daytime while also providing a desirable amount of light during nighttime or other obscured light times. The advanced sunroof lighting system consists of multiple layers. In an embodiment, a first transparent layer and a second transparent layer substantially sandwich a tint layer. This tint layer is electrically controllable to allow none, some, or all (neglecting any scattering that occurs by the tint layer itself) of the natural sunlight that is incident on the sunroof to pass through the tint layer. The advanced sunroof lighting system may also have a transparent lighting layer between the first and second transparent layers, such as between the tint layer and the second transparent layer. This transparent lighting layer has a plurality of light sources that are preferentially light emitting diodes (LEDs) attached to a control mechanism, such as a variable power source or a variable resister, that allows for the tuning of the LED intensity and/or color. Because the light in the transparent lighting layer is from the sides, the layer has a plurality of scattering centers, which serve to redirect the light from the light sources on the side of the layer towards the vehicle cabin and the occupants within.

In embodiments, the advanced sunroof lighting system has an electrical controller to control whether the tint layer is tinted and that can also control the brightness and/or color of the lights. The driver or other occupants may interface with the electrical controller through a user interface shown on the dashboard, a computer screen attached to the vehicle, or a remote application (such as an app running on a mobile device). When selected by the user (or according to certain rules automatically set up or set up by the user), the controller changes the level of tinting. For example, during a morning commute, the user may select (or a program set up) for the controller to lighten the tint layer to selectively allow a portion of light through to the vehicle cabin. The user can also control the transparent lighting layer through the controller to have the layer emit light from the plurality of light sources to illuminate the interior cabin to a desired lighting level or a desired color level.

### BRIEF DESCRIPTION OF THE FIGURES

FIG. 1 illustrates a side profile of an exemplary vehicle according to certain embodiments of the invention.

FIG. 2 illustrates a partial cross-sectional view of an advanced sunroof lighting system according to certain embodiments of the invention.

FIG. 3 a schematic illustration of a transparent lighting layer according to certain embodiments of the invention.

FIG. 4 illustrates a user interface and a controller for controlling the advanced sunroof lighting system according to certain embodiments of the invention.

FIG. 5 illustrates the operation of the advanced sunroof lighting system in a first mode of operation according to certain embodiments of the invention.

FIG. 6 illustrates the operation of the advanced sunroof lighting system in a second mode of operation according to certain embodiments of the invention.

FIG. 7 illustrates the operation of the advanced sunroof lighting system in another embodiment of the second mode of operation.

FIG. 8 illustrates the operation of the advanced sunroof lighting system in a third mode of operation according to certain embodiments of the invention.

FIG. 9 illustrates the user interface that allows a user to interface with the advanced sunroof lighting system according to certain embodiments of the invention.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting it.

### DETAILED DESCRIPTION

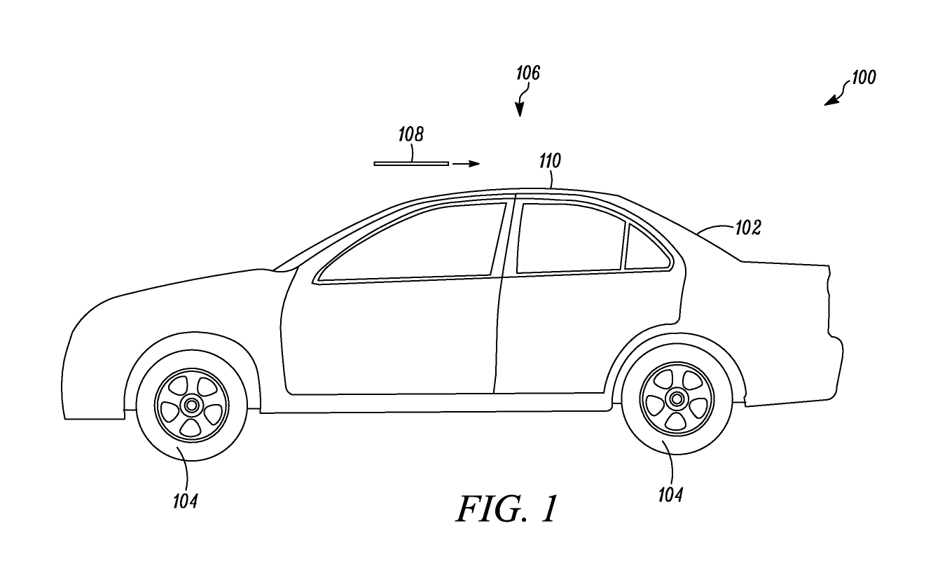

FIG. 1 illustrates a side profile of an exemplary vehicle 100 such as, for example, a passenger car, truck, sport utility vehicle, or van. Vehicle 100 includes a frame 102 that is supported by a set of wheels 104. Vehicle 100 includes a power source (not shown) configured to propel vehicle 100. An advanced sunroof lighting system 106 includes a sunroof 108 installed in a roof 110 of vehicle 100 moves fore and aft along a set of tracks. Sunroof 108 is shown schematically above roof 110 for ease in visualization but it is understood that it is installed in roof 110 and may cover all or most of the roof 110 as shown and described elsewhere herein. In certain embodiments of the invention, sunroof 108 may be installed as a fixed window of vehicle 100.

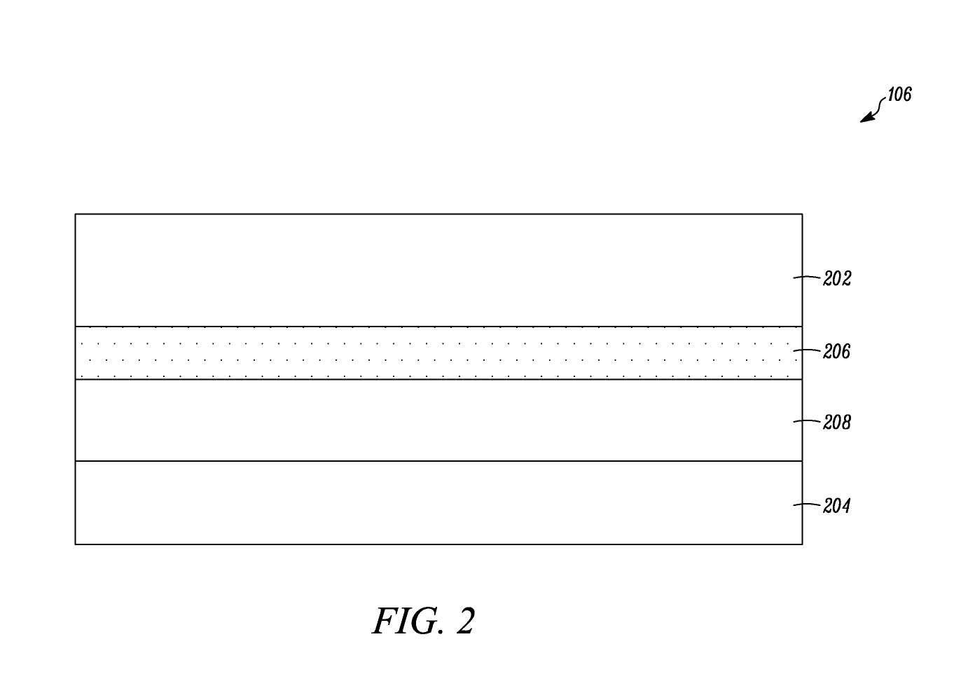

FIG. 2 is a partial cross-sectional view of advanced sunroof lighting system 106 in accordance with certain embodiments of the invention. Sunroof 108 may consist solely of advanced sunroof lighting system 106, or advanced sunroof lighting system 106 may only be a portion of the sunroof (for example, around the edges of the sunroof). Sunroof lighting system 106 has a first transparent layer 202 and a second transparent layer 204. Second transparent layer 204 is substantially parallel to first transparent layer 202. First transparent layer 202 and/or second transparent layer 204 may be made of transparent substrates of glass, plastic, composite or other material, as may be desired, that functions as a transparent substrate. First transparent layer 202 and second transparent layer 204 allow substantially all the light incident on them to pass through.

As shown in the illustrated embodiment of FIG. 2, advanced sunroof lighting system 106 includes a tint layer 206 disposed between first transparent layer 202 and second transparent layer 204. Tint layer 206 is electrically controllable to allow a portion of light incident on tint layer 206 to pass through. Tint layer 206 may be a smart glass or switchable glass that blocks some or all wavelengths of light when activated. The tint layer 206 may be activated through the application of a voltage or current. Alternatively, the tint layer 206 may be activated without application of a voltage or current, becoming transparent when a voltage or current is applied. In alternate embodiments, tint layer 206 is a liquid crystal display, electrochromic display, suspended particle device (SPD), NanoChromics display (NCD), or organic electroluminescent display (OELD) element and a semiconductor element for controlling an operation of tint layer 206.

Tint layer 206 may be electrically controlled to allow none, some, or all of the natural sunlight that is incident on advanced sunroof lighting system 106. For instance, tint layer 206 may be darkened when the vehicle occupants do not want the sunlight and tint layer 206 may be transparent or clear when the vehicle occupants want the sunlight. In certain embodiments of the invention, tint layer 206 with an SPD display element may be darkened by adjusting the voltage to the electrodes of the SPD display element using, for example, a rheostat. In other embodiments of the invention, tint layer 206 with a liquid crystal display element may be darkened by using small pixels which can be switched ON and OFF to create patterns that provide different degrees of shading. In certain embodiments of the invention, tint layer 206 may be controlled automatically based on a control signal generated using a sensor, for example, ambient light sensor. However, it may be noted that other sensors may be implemented by persons skilled in the art to automatically control tint layer 206 of sunroof 108. Whether operated manually or automatically, tint layer 206 offers a way to let controlled amount of natural light in vehicle 100.

As shown in the illustrated embodiment of FIG. 2, advanced sunroof lighting system 106 includes a transparent lighting layer 208 disposed between tint layer 206 and second transparent layer 204. Transparent lighting layer 208 can emit light towards the cabin of vehicle 100. When not emitting light, transparent lighting layer 208 acts as substantially transparent layer allowing almost all the light incident on transparent lighting layer 208 to pass through. Transparent lighting layer 208 may be glass or plastic with particles dispersed within. In certain embodiments, the particles are dispersed to in a gradient such that there are fewer particles on the side and more particles in the center. Because the particles act as scattering centers and the light may impinge from the side, such a gradient of particles creates uniform light distribution.

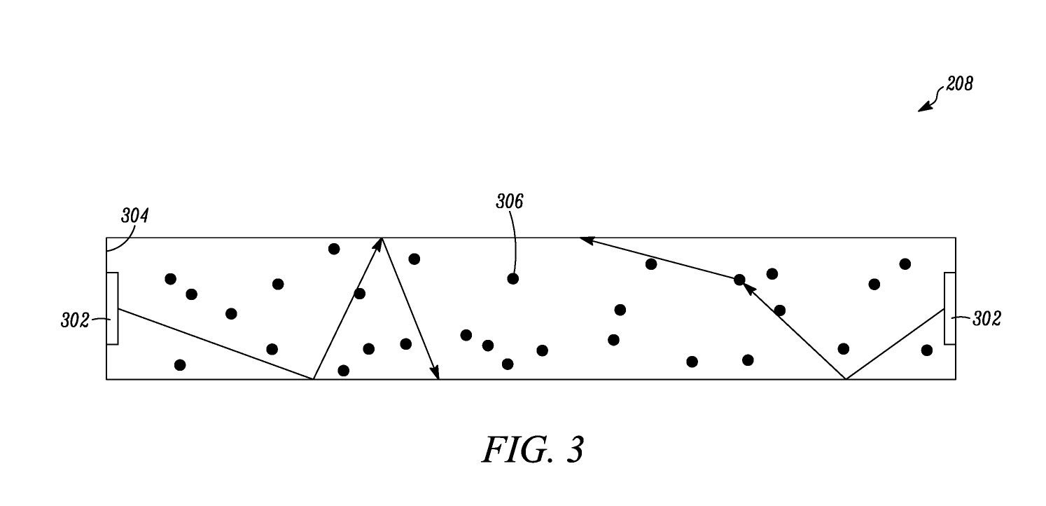

FIG. 3 is a schematic illustration of transparent lighting layer 208 in accordance with certain embodiments of the invention. Transparent lighting layer 208 comprises a plurality of light sources 302, attached to a substrate 304, that are electrically controllable to emit light. Substrate 304 may be made of glass, plastic, composite or other materials known in the art. Light sources 302 may be designed to give a more diffused general lighting in the cabin of vehicle 100. Light sources 302 may be monochromatic light emitting diodes (LEDs), organic LEDs (OLEDs), and/or polychromatic RGB LEDs. Light sources 302 may employ reflectors and/or a lens shaped to produce a more diffused light that illuminates a general area instead of a focused beam. LED electrical connections (not shown) are made to substrate 304 by various means including solder, Ag-epoxy, anisotropic conducting adhesives, and other materials known in the art. Conducting traces (not shown) from active devices and power sources can be made on either side of substrate 304. In certain embodiments of the invention, light sources 302 (also referred to as LEDs 302) may be disposed along edges or periphery of transparent lighting layer 208. However, it may be noted that light sources 302 may be disposed at various other locations in transparent lighting layer 208 without deviating from the spirit of the invention.

Transparent lighting layer 208 further comprises a plurality of scattering centers 306 configured to redirect light received from light sources 302 towards the cabin of vehicle 100 and the occupants. Scattering centers 306 may be strongly scattering particles such as titanium oxide nanoparticles (TiO₂) embedded in transparent lighting layer 208. Transparent lighting layer 208 may be made by resin deposition methods known in the art or may be a single layer incorporating homogeneous or inhomogeneous density of scattering centers 306 such that different regions of transparent lighting layer 208 have uniform or non-uniform number of scattering centers 306, respectively. Inhomogeneous density of scattering centers 306 may be achieved by time-multiplexed or spatial multiplexed dispensing methods known in the art. In certain embodiments of the invention, scattering centers 306 are dispersed in a predetermined pattern. The pattern may be designed such that regions adjacent to edges of transparent lighting layer 208 have a lower density of scattering centers 306 and regions adjacent to a center of transparent lighting layer 208 have a higher density of scattering centers 306. In other embodiments, the pattern may be designed such that density of scattering centers 306 linearly or non-linearly decreases as the distance from the center of transparent lighting layer 208 increases.

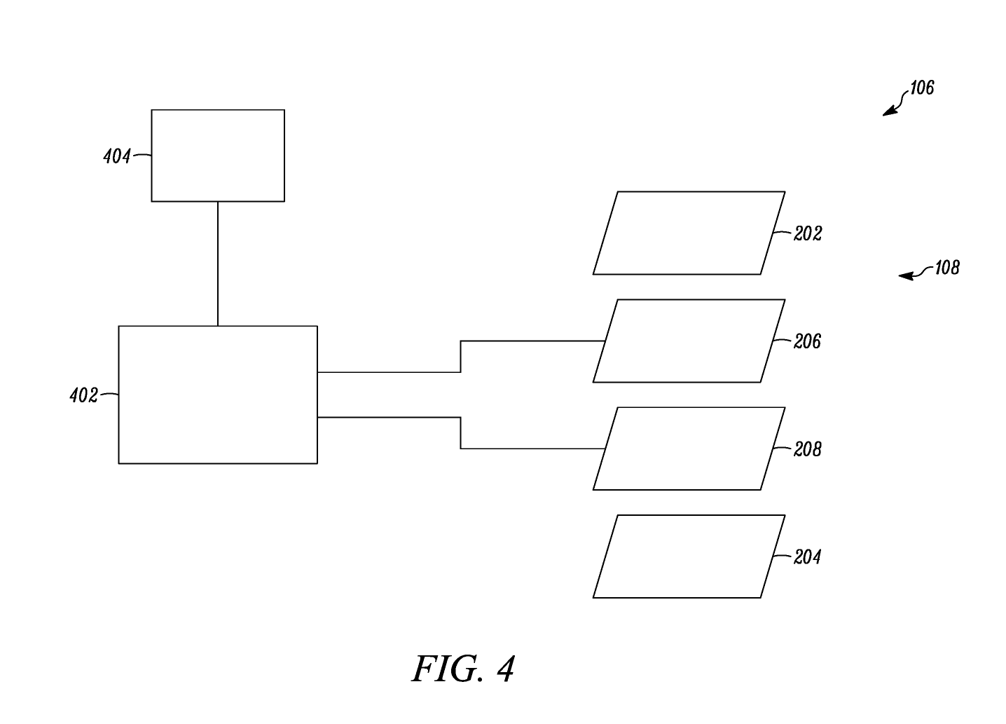

FIG. 4 illustrates advanced sunroof lighting system 106 of vehicle 100 in accordance with certain embodiments of the invention. Advanced sunroof lighting system 106 includes sunroof 108 having first transparent layer 202, second transparent layer 204, tint layer 206, and transparent lighting layer 208. Advanced sunroof lighting system 106 further includes a controller 402 electrically connected with the one or more aforementioned layers. More specifically, controller 402 is connected to tint layer 206 and transparent lighting layer 208. Controller 402 may be connected to sunroof 108 in a wireless manner or using a wired connection.

As shown in FIG. 4, controller 402 is electrically connected with tint layer 206. Controller 402 is configured to control tint layer 206 to selectively allow a portion of light incident on tint layer 206 to pass through. In certain embodiments, controller 402 controls electronic circuitry of tint layer 206, such as, electrodes, liquid crystal elements, to control the portion of light that is allowed to pass through tint layer 206.

Further, controller 402 is electrically connected to transparent lighting layer 208 to control light emitted from light sources 302. In certain embodiments, controller 402 may be configured to vary the color of light emitted from light sources 302. To achieve this, light sources 302 may be constructed from a plurality of individual LEDs 302 having different emission spectra. By controlling the relative intensities of LEDs 302, controller 402 may enable transparent lighting layer 208 to emit light of any color.

Alternatively, light sources 302 may provide light of a single color and scattering centers 306 may comprise of phosphors that convert the LED light to light of a spectrum determined by the phosphors. For example, light sources 302 comprising one or more LEDs that emit in the ultraviolet or blue portion of the spectrum may be used to excite a mixture of phosphors to provide light of a particular spectrum. The phosphors may be in the form of particles that are dispersed in the material of transparent lighting layer 208 or the phosphors may be chosen from the class of phosphors that are soluble in the material from which transparent lighting layer 208 is constructed.

Unlike fluorescent light sources, the intensity of light from light sources 302 can be varied by varying the intensity of light from LEDs 302. Controller 402 may be configured to vary the perceived light intensity from LEDs 302, by altering the current through LEDs 302 or by varying the duty cycle of LEDs 302. In case of varied duty cycle, controller 402 controls each LED 302 to switch on and off over a time period that is too small to be perceived by a human observer. The perceived intensity of light is determined by the fraction of the time over which LED 302 is turned on during a given cycle. Controller 402 may be configured to control transparent lighting layer 208 to provide a uniform distribution of light in the interior space of vehicle 100.

Controller 402 may be a single microprocessor or multiple microprocessors that include components for performing functions consistent with the present disclosure. Numerous commercially available microprocessors can be configured to perform the functions of controller 402 disclosed herein. It should be appreciated that controller 402 could readily be embodied in a general purpose microprocessor capable of controlling numerous functions associated with each of the devices present in vehicle 100. Controller 402 may also include a memory, a secondary storage device, and any other components for running an application. Various circuits may be associated with controller 402 such as power supply circuitry, a solenoid driver circuitry, a signal conditioning circuitry for e.g., an analog-to-digital converter circuitry, and other types of circuitry. Various routines, algorithms, and/or programs can be programmed within controller 402 for execution thereof. Moreover, it should be noted that controller 402 disclosed herein may be a stand-alone controller 402 or may be configured to co-operate with existing processor/s, for example, an electronic control module (ECM) (not shown) provided to vehicle 100 to perform functions that are consistent with the present disclosure.

Referring to FIG. 4, advanced sunroof lighting system 106 further includes a user interface 404. User interface 404 may be electrically connected to controller 402. User interface 404 may be a touch screen configured to receive touch inputs from a user or an occupant of vehicle 100. The user may provide an input associated with control of at least one of tint layer 206 and transparent lighting layer 208. In other words, the user may select, on user interface 404, an appropriate mode of operation of advanced sunroof lighting system 106 out of multiple modes. Consequently, controller 402 may detect the mode of operation that is being selected by the user and provide appropriate control signals to the sunroof 108 of vehicle 100 so that advanced sunroof lighting system 106 is controlled in a desired manner. The user input may be provided by selecting from menu options listed on user interface 404. In other embodiments of this invention, the user can provide a voice command to user interface 404 in lieu of physically selecting a menu option to control advanced sunroof lighting system 106 of vehicle 100. In certain embodiments of the invention, user interface 404 may be a remote controller wirelessly connected with controller 402. The remote controller may be operable by the user to provide user input to control advanced sunroof lighting system 106.

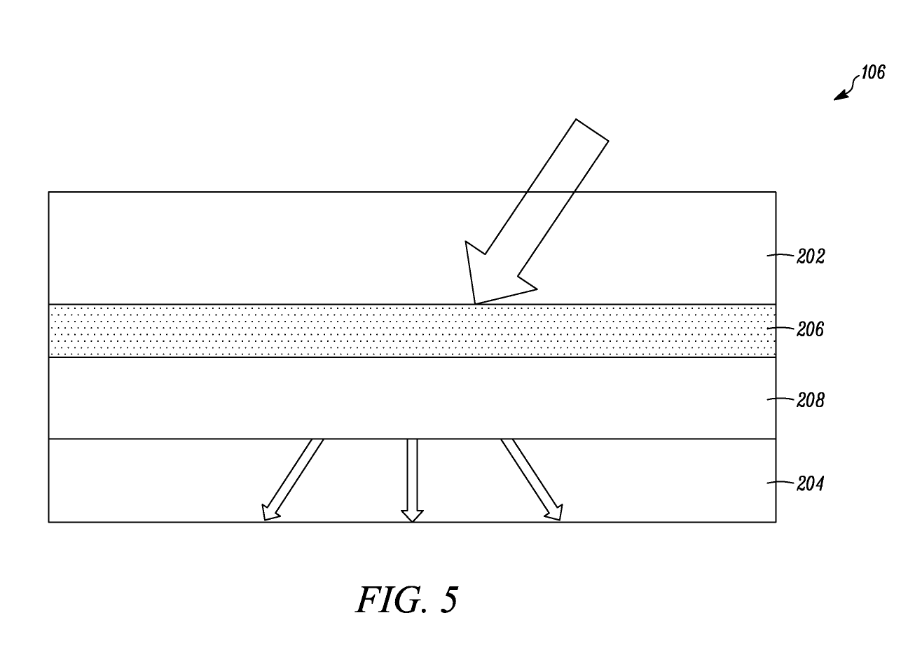

FIG. 5 illustrates the operation of advanced sunroof lighting system 106 in a first mode of operation in accordance with certain embodiments of the invention. In the first mode, controller 402 is configured to control transparent lighting layer 208 to provide light to the cabin of vehicle 100. This mode may be used to provide an appropriate lighting in the cabin of vehicle 100 at night or when vehicle 100 does not have access to sunlight (for example, while passing through a tunnel). In such cases, although there is very low light incident on tint layer 206, controller 402 may be configured to control tint layer 206 to substantially block the light incident on tint layer 206 to avoid interference with the light provided by transparent lighting layer 208.

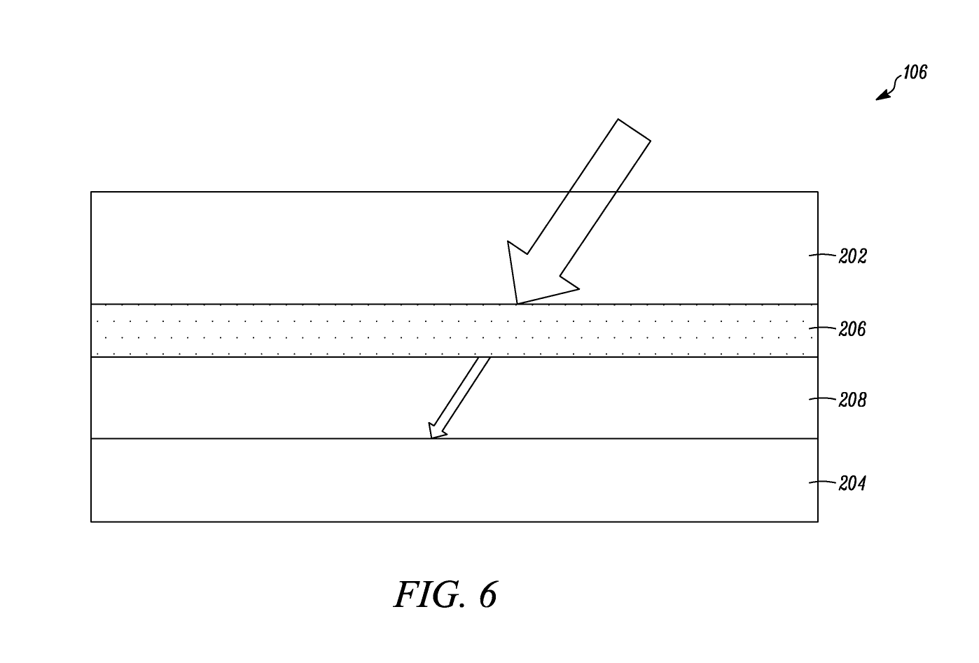

FIG. 6 illustrates the operation of advanced sunroof lighting system 106 in a second mode of operation in accordance with certain embodiments of the invention. In the second mode, controller 402 is configured to control light sources 302 of transparent lighting layer 208 so that light sources 302 do not emit light. In case LEDs 302 are used as light sources 302, controller 402 may be configured to switch OFF all LEDs 302 provided in transparent lighting layer 208 in the second mode of operation. Further, in the second mode, controller 402 is configured to control tint layer 206 to allow substantially all of the light incident on tint layer 206 to pass through. This mode may be used in daytime to allow ambient sunlight to enter the interior space of vehicle 100.

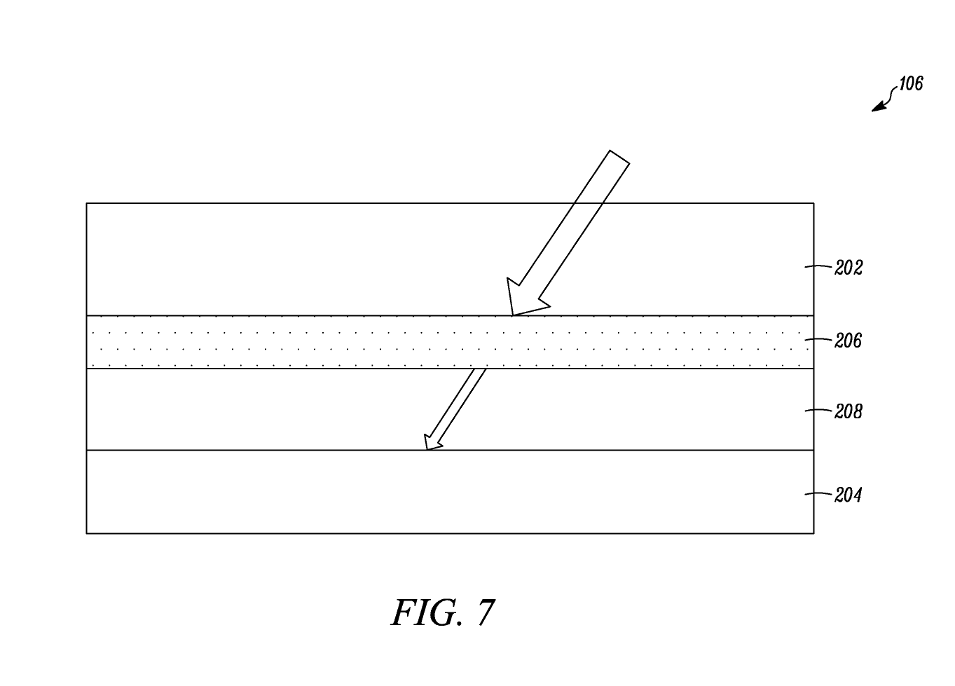

FIG. 7 illustrates another embodiment of a second mode of operation of advanced sunroof lighting system 106. Controller 402 is configured to control tint layer 206 to allow substantially all of the moonlight incident on tint layer 206 to pass through. This mode may be used at night to allow ambient moonlight to enter the cabin of vehicle 100.

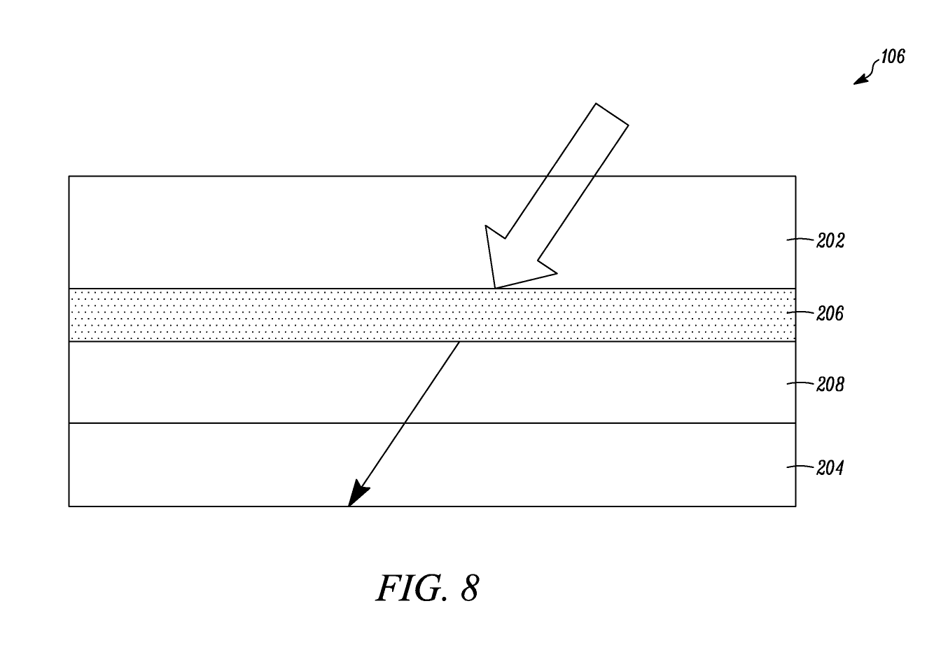

FIG. 8 illustrates the operation of advanced sunroof lighting system 106 in a third mode of operation in accordance with certain embodiments of the invention. In the third mode, controller 402 is configured to control light sources 302 of transparent lighting layer 208 so that light sources 302 do not emit light. In case LEDs 302 are used as light sources 302, controller 402 may be configured to switch OFF all LEDs 302 provided in transparent lighting layer 208 in the third mode of operation. Further, in the third mode, controller 402 is configured to control tint layer 206 to block substantially all of the light incident on tint layer 206 to pass through. This mode may be used in daytime to block ambient sunlight to enter the cabin of vehicle 100.

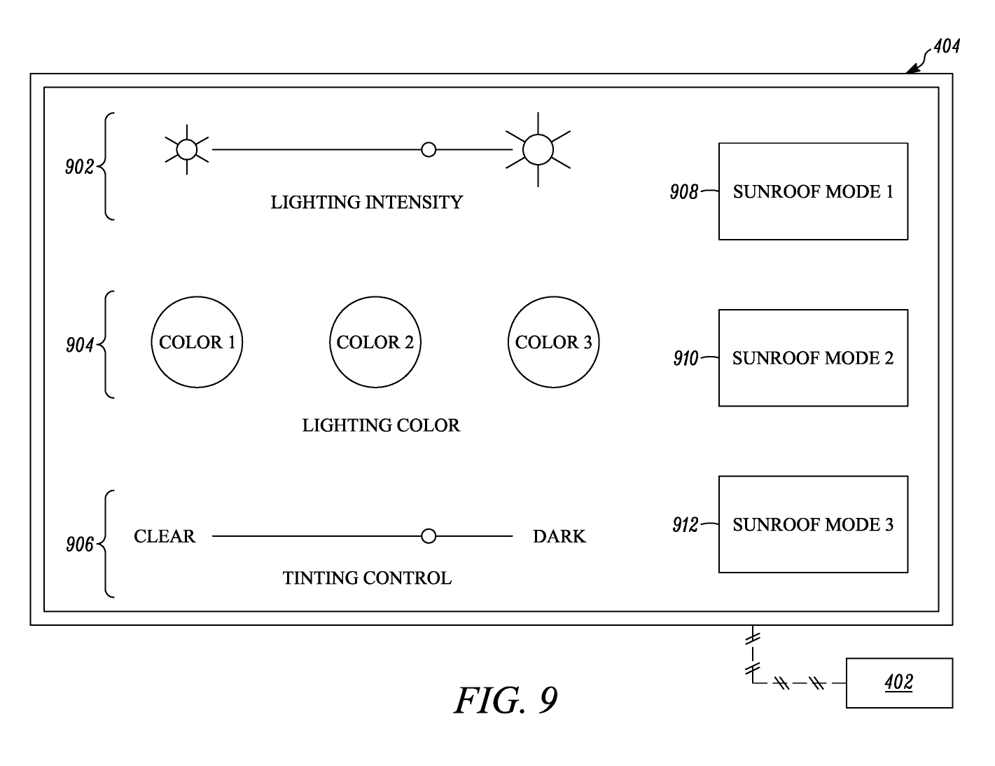

FIG. 9 illustrates user interface 404 that allows a user to interface with advanced sunroof lighting system 106 according to certain embodiments of the invention. The driver or other occupants may interface with controller 402 through user interface 404. User interface 404 may be a computer screen attached to vehicle 100, for example, mounted on the dashboard. In certain embodiments, user interface 404 may be a remote application (such as an app running on a mobile device). The user can control transparent lighting layer 208 through controller 402 to have the layer emit light from light sources 302 to illuminate the cabin of vehicle 100 to a desired intensity level or a desired color level using a first slider 902 and color controls 904 respectively. When selected by the user (or according to certain rules automatically set up or set up by the user), controller 402 can also control the level of tinting using a second slider 906 displayed on user interface 404. For example, the user may select (or a program set up) for controller 402 to set the tint layer towards “CLEAR” in morning hours to selectively allow a portion of light through to the cabin of the vehicle 100. The user can also select the mode of operation of advanced sunroof lighting system 106 through controller 402 using mode controls 908, 910, and 912 provided on user interface 404.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, a person of ordinary skill in the art will recognize that changes may be made in form and detail without departing from the scope of the present disclosure. Thus, the present disclosure is limited only by the claims.

In the foregoing specification, the disclosure has been described with reference to specific embodiments. However, as one skilled in the art will appreciate, various embodiments disclosed herein can be modified or otherwise implemented in various other ways without departing from the spirit and scope of the disclosure. Accordingly, this description is to be considered as illustrative and is for the purpose of teaching those skilled in the art the manner of making and using various embodiments of the disclosed air vent assembly. It is to be understood that the forms of disclosure herein shown and described are to be taken as representative embodiments. Equivalent elements, materials, processes or steps may be substituted for those representatively illustrated and described herein. Moreover, certain features of the disclosure may be utilized independently of the use of other features, all as would be apparent to one skilled in the art after having the benefit of this description of the disclosure. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

Further, various embodiments disclosed herein are to be taken in the illustrative and explanatory sense, and should in no way be construed as limiting of the present disclosure. All joinder references (e.g., attached, affixed, coupled, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer that two elements are directly connected to each other.

Additionally, all numerical terms, such as, but not limited to, “first”, “second”, “third”, “primary”, “secondary”, “main” or any other ordinary and/or numerical terms, should also be taken only as identifiers, to assist the reader's understanding of the various elements, embodiments, variations and/or modifications of the present disclosure, and may not create any limitations, particularly as to the order, or preference, of any element, embodiment, variation and/or modification relative to, or over, another element, embodiment, variation and/or modification.

It will also be appreciated that one or more of the elements depicted in the drawings/figures can also be implemented in a more separated or integrated manner, or even removed or rendered as inoperable in certain cases, as is useful in accordance with a particular application. Additionally, any signal hatches in the drawings/figures should be considered only as exemplary, and not limiting, unless otherwise specifically specified.

What is claimed is:

1. A sunroof for a vehicle comprising:
a first transparent layer;
a second transparent layer substantially parallel to the first transparent layer;
a tint layer disposed between the first transparent layer and the second transparent layer, wherein the tint layer is electrically controllable to allow a portion of light incident on the tint layer to pass through the tint layer; and
a transparent lighting layer disposed between the tint layer and the second transparent layer, the transparent lighting layer comprising:
a plurality of light sources electrically controllable to emit light; and
a plurality of scattering centers configured to redirect light received from the plurality of light sources towards the vehicle's cabin.

2. The sunroof of claim 1, wherein at least one of the first transparent layer and the second transparent layer is made of glass.

3. The sunroof of claim 1, wherein the plurality of light sources comprises at least one light emitting diode and wherein a user interface controls the brightness and the color of the light emitted from the light sources.

4. The sunroof of claim 1, wherein the plurality of light sources are disposed along edges of the transparent lighting layer.

5. The sunroof of claim 1, wherein the transparent lighting layer is configured to provide a uniform distribution of light into the vehicle's cabin.

6. The sunroof of claim 1, wherein the plurality of scattering centers are titanium dioxide particles.

7. The sunroof of claim 1, wherein the plurality of scattering centers are uniformly dispersed throughout the transparent lighting layer.

8. The sunroof of claim 1, wherein the plurality of scattering centers are dispersed in a pattern, the pattern having a lower density of scattering centers in regions adjacent to edges of the transparent lighting layer and a higher density of scattering centers in regions adjacent to a center of the transparent lighting layer.

9. The sunroof of claim 1, wherein the sunroof is movable along a frame of the vehicle between an open position and a closed position.

10. A sunroof lighting system for a vehicle:
a sunroof comprising:
a first transparent layer;
a second transparent layer substantially parallel to the first transparent layer;
a tint layer disposed between the first transparent layer and the second transparent layer, wherein the tint layer is electrically controllable to allow a portion of light incident on the tint layer to pass through the tint layer; and
a transparent lighting layer disposed between the tint layer and the second transparent layer, the transparent lighting layer comprising:
a plurality of light sources electrically controllable to emit light; and
a plurality of scattering centers configured to redirect light received from the plurality of light sources towards the vehicle's cabin; and
a controller in electrical communication with the sunroof, the controller configured to:
control the tint layer to selectively allow a portion of light incident on the tint layer to pass through the tint layer; and
control the transparent lighting layer to selectively emit light from the plurality of light sources towards the vehicle's cabin.

11. The sunroof lighting system of claim 10, wherein the controller is configured to operate the sunroof lighting system in a first mode in which the plurality of light sources of the transparent lighting layer provide light into the vehicle's cabin.

12. The sunroof lighting system of claim 10, wherein the controller is configured to operate the sunroof lighting system in a second mode in which the plurality of light sources of the transparent lighting layer do not emit light and the tint layer allows substantially all of the light incident on the tint layer to pass through the tint layer.

13. The sunroof lighting system of claim 10, wherein the controller is configured to operate the sunroof lighting system in a third mode in which the plurality of light sources of the transparent lighting layer do not emit light and the tint layer blocks substantially all of the light incident on the tint layer.

14. The sunroof lighting system of claim 10, wherein a user controls the controller through a user interface that allows the user to select brightness and color of the light emitted by the transparent lighting layer.

15. A vehicle comprising:
a frame;
a set of wheels configured to support the frame;
a power source configured to propel the vehicle;
a sunroof configured to move along a part of the frame, comprising:
a first transparent layer;
a second transparent layer substantially parallel to the first transparent layer;
a tint layer disposed between the first transparent layer and the second transparent layer, wherein the tint layer is electrically controllable to allow a portion of light incident on the tint layer to pass through the tint layer; and
a transparent lighting layer disposed between the tint layer and the second transparent layer, the transparent lighting layer comprising:
a plurality of light sources electrically controllable to emit light; and
a plurality of scattering centers configured to redirect light received from the plurality of light sources towards the vehicle's cabin; and
a controller in electrical communication with the sunroof, the controller configured to:
control the tint layer to selectively allow a portion of light incident on the tint layer to pass through the tint layer; and
control the transparent lighting layer to selectively emit light from the plurality of light sources towards the vehicle's cabin.

16. The vehicle of claim 15, wherein the controller transmits wireless communication signals to the sunroof

17. The vehicle of claim 15, further comprising a user interface connected to the controller, the user interface operable to receive an input from a user, wherein the inputs available include an adjustment to the tint layer and an adjustment to the transparent lighting layer.

18. The vehicle of claim 17, wherein the user interface comprises a touch screen.

19. The vehicle of claim 17, wherein the input from the user is a voice command.

20. The vehicle of claim 15, wherein the sunroof is configured to move along the part of the frame between an open position and a closed position.
